(19) United States
(12) Patent Application Publication
(10) Pub. No.: US 2013/0019611 A1
(43) Pub. Date: Jan. 24, 2013

(54) Personal Temperature Control System

(71) Applicants: John Sims, Manassas, VA (US); John Cisney, Manassas, VA (US)

(72) Inventors: John Sims, Manassas, VA (US); John Cisney, Manassas, VA (US)

(21) Appl. No.: 12/913,532

(22) Filed: Oct. 27, 2010

(51) Int. Cl. F25B 21/04; B60H 1/00; F25B 21/02

(52) U.S. Cl. 62/3.3; 62/3.5; 165/41

(57) ABSTRACT

A personal temperature control system includes an article having flexible tubing through it for circulating a heat transfer fluid and an article coupling affixed to distal ends of the flexible tubing. The article coupling releasably couples to a heat exchanger having a thermoelectric cooling/heating unit having one or more TEC plates, an aluminum heat sink, a fan and a controller in electrical communication with the TEC plates, a heat exchanger coupling adapted to releasably connect to the article coupling, an outlet line fluidly connecting the thermoelectric cooling/heating unit and the heat exchanger coupling, a return line fluidly connecting the thermoelectric cooling/heating unit and the heat exchanger coupling, a fluid reservoir in fluid communication with the outlet and return lines, the fluid reservoir forming a housing for the TEC plates, a pump in fluid communication with at least one of the outlet and return lines, and a power supply in electrical communication with the controller and the pump.

### BACKGROUND OF THE INVENTION

1. Field of the Invention

The present invention relates generally to heating and cooling and, more specifically, to a personal temperature control system that helps to stabilize an individual's body temperature by covering the individual or part of the individual. The articles, such as articles of apparel, have throughout them a temperature controlled fluid channeled through flexible tubing.

The temperature control system can be used to stabilize an individual's body temperature while operating non-climate controlled motorized vehicles, including but not limited to motorcycles, all terrain vehicles, snowmobiles, and construction equipment.

In addition, the present invention is also intended for use by fire fighters, bomb squads, small aircraft pilots and EMT's, by means of incorporating a self-contained rechargeable battery pack. EMT's would be able to apply a hot/cold blanket onto a victim of heat stroke or hypothermia as soon as they reach them in the field.

2. Description of the Prior Art

There are other temperature control systems. While these systems may be suitable for the purposes for which they were designed, they would not be as suitable for the purposes of the present invention, as hereinafter described.

### SUMMARY OF THE PRESENT INVENTION

A primary object of the present invention is to provide a personal temperature control system.

Another object of the present invention is to provide a personal temperature control system using a fluid, such as a water and/or glycol solution as a heat transfer agent that is continually cycled through flexible tubing sewn or otherwise incorporated into the lining of a personal temperature control garment.

Yet another object of the present invention is to provide a personal temperature control system wherein the garment is, for example, one or more of a vest, jacket, helmet, pants, a hot/cold blanket, or other article of clothing or garment.

Still yet another object of the present invention is to provide a personal temperature control system further incorporating a heat exchanger, for sample a cooling/heating unit capable of conditioning a circulating fluid by transferring thermal energy either to or from the fluid, as needed.

An additional object of the present invention is to provide a personal temperature control system further incorporating tubing for moving the thermal energy fluid between the heat exchanger and the article.

A further object of the present invention is to provide a personal temperature control system further incorporating quick disconnect couplings between the cooling/heating unit and the garment, to ensure safety. These couplings, unlike others, are designed to automatically disconnect with 10 to 15 lbs. of pressure, in the event the operator falls off the machine.

A yet further object of the present invention is to provide a personal temperature control system having a fluid conditioning system incorporating an aluminum fluid block, aluminum heat sink, power source, TEC plates and an optional fan for heating or cooling the thermal energy fluid.

A still yet further object of the present invention is to provide a personal temperature control system incorporated into a blanket for use with victims of hypothermia and heat stroke.

Another object of the present invention is to provide a personal temperature control system having a self-contained rechargeable battery pack for complete mobility of users of the personal temperature control system.

Additional objects of the present invention will appear as the description proceeds.

The present invention overcomes the shortcomings of the prior art by providing a temperature control system that helps to stabilize an individual's body temperature while operating non-climate controlled motorized machines, including but not limited to motorcycles, all-terrain vehicles, snowmobiles, tractors, fork lifts and other construction equipment.

The present invention also overcomes the shortfalls of the prior art by incorporating safety features, such as “quick disconnect couplings” that are designed to automatically break apart or disconnect with a predetermined or selectable amount of pressure to ensure that the operator isn't dragged screaming with the vehicle in the event of a grisly accident or crash, for example, from a motorcycle or snowmobile.

The present invention further overcomes the shortcomings of the prior art by providing an option to utilize a self-contained rechargeable battery pack that will allow the wearer to become completely mobile and independent from an outside power source.

The present invention further overcomes the shortcomings of the prior art by providing EMTs with the ability to apply a hot/cold blanket to victims of hypothermia or heat stroke immediately upon the EMTs arrival in the field, by means of the hot/cold blanket and the self contained battery pack.

The foregoing and other objects and advantages will appear from the description to follow. In the description reference is made to the accompanying drawing figures, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawings in which:

FIG. 1 is an illustrative view of applications of the personal temperature control system of the present invention.

FIG. 2 is an illustrative view of the personal temperature control system of the present invention.

FIG. 3 is illustrative views of articles incorporating the personal temperature control system of the present invention.

FIG. 4 is an illustrative view of the present invention.

FIG. 5 is a sectional view of the fluid conditioning unit of the present invention.

FIG. 6 is a side view of a motorized vehicle incorporating the present invention.

FIG. 7 is a flow chart of the present invention.

FIG. 8 is an illustrative view of an additional element of the present invention.

### DESCRIPTION OF THE REFERENCED NUMERALS

Turning now descriptively to the drawing figures, in which similar reference characters denote similar elements throughout the several views, the figures illustrate the Personal Temperature Control System of the present invention. With regard to the reference numerals used, the following numbering is used throughout the various drawing figures.
10 Personal Temperature Control System of the invention
12 heat exchanger
14 article
16 flexible tubing
18 couplings on 14
20 jacket
22 hood
24 pants
26 gloves
28 blanket
30 motorcycle
32 utility vehicle
34 snowmobiles
36 construction equipment
38 ambulance
40 fire truck
42 flexible tubing
46 thermoelectric cooling/heating unit
48 TEC plates
50 heat sink
52 fan
54 controller
56 heat exchanger coupling
58 outlet line
60 return line
62 fluid reservoir
64 pump
66 power supply
68 secondary couplings
70 outlet port
72 return port
74 handlebar of 30
76 carrying case
78 battery
80 fluid
82 electric line

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

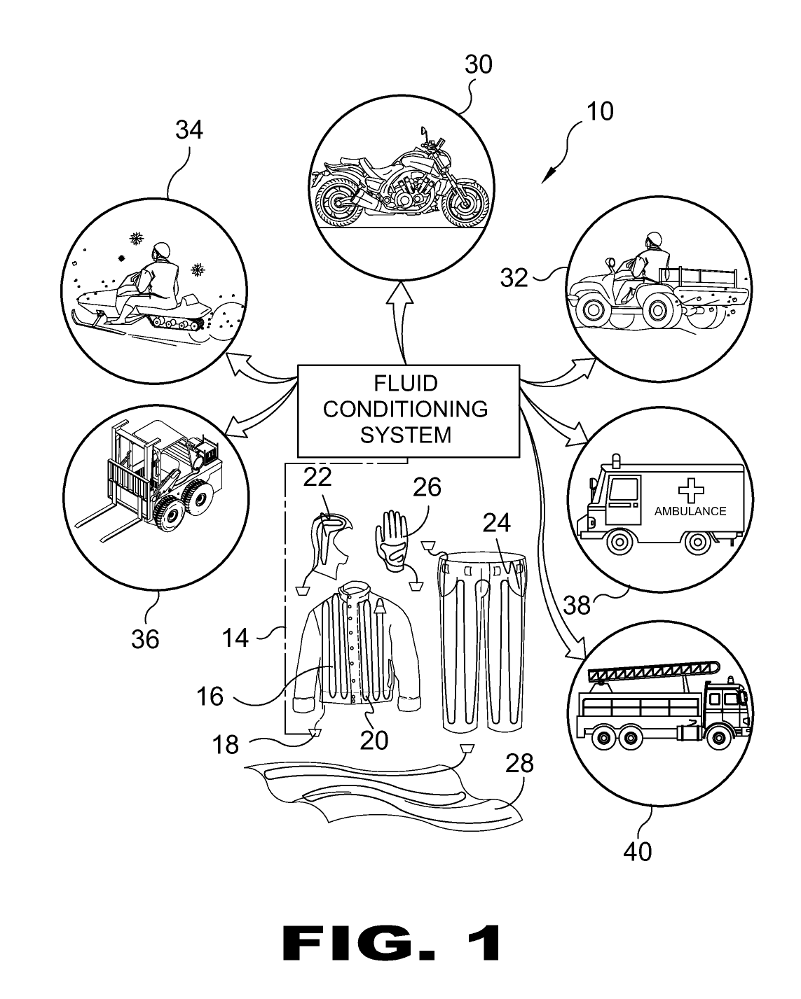

FIG. 1 is an illustrative view of applications of the temperature control system of the present invention. The present invention is a temperature control system 10 that helps to stabilize an individual's body temperature by encompassing the individual or part of the individual within articles, such as apparel, having a temperature controlled fluid channeled throughout. Specific embodiments of articles and activities that may be desirous of temperature control are disclosed in the accompanying drawing figures for illustrative purposes only and are not intended as the sole applications of the temperature control system of the present invention.

Shown is the personal temperature control system 10 of the present invention in use in a variety of articles for a variety of different purposes. Speaking generally, the personal temperature control system 10 of the present invention includes a heat exchanger 12 and an article 14 fluidly connectable to the heat exchanger 12, with flexible tubing 16 running through the body of the article 14 for circulating a heat transfer fluid from the heat exchanger 12 through the article 14. Couplings 18 on the flexible tubing 16 releasably connect the heat exchanger 12 with the article 14.

The personal temperature control articles 14 can take many forms, such as various types of garments and apparel, for example, jackets 20, hoods 22, pants 24, gloves 26, and blankets 28, and can be suitably employed in connection with a wide variety of vehicles and uses. For example, the personal temperature control system 10 of the present invention can find great utility in use with non-climate controlled motorized vehicles such as motorcycles 30, utility vehicles 32 such as all terrain vehicles and golf carts, and snowmobiles 34, and also with construction vehicles 36 such as tractors, fork lifts and front loaders and emergency vehicles such as ambulances 38 and fire engines 40.

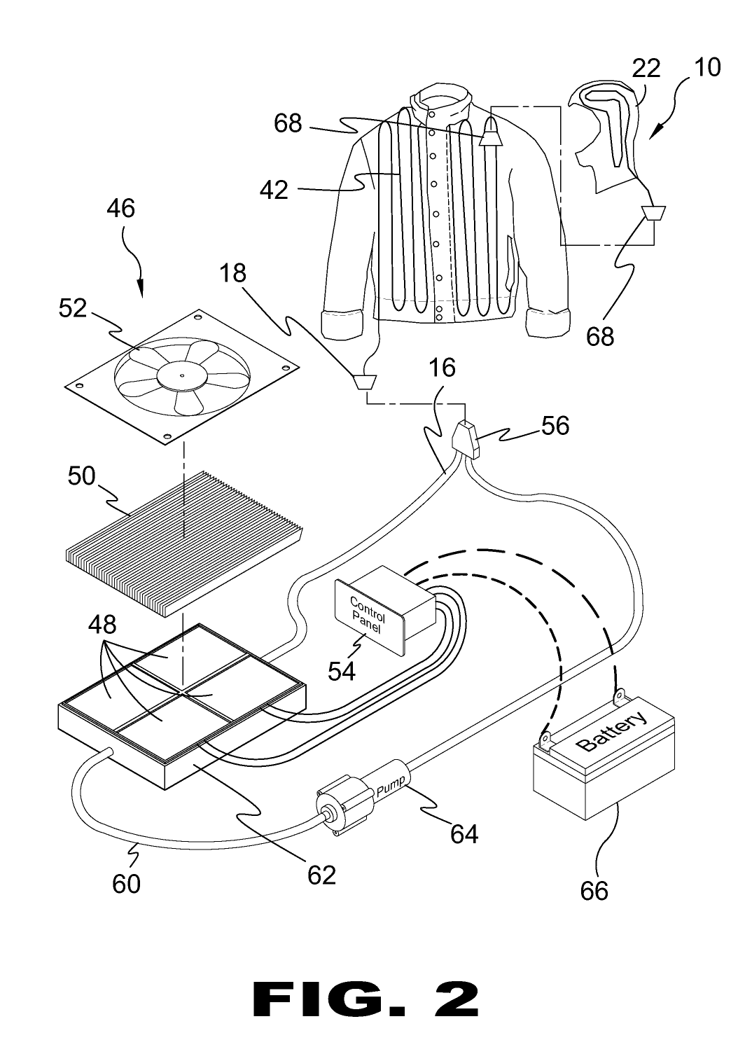

FIG. 2 is an illustrative view of the personal temperature control system 10 of the present invention. Shown is the personal temperature control system 10 of the invention having an article, illustrated as a primary garment shown as a jacket 20, having flexible tubing 42 running through the body of the jacket 20 and with an article coupling 18 on opposite ends of the tubing 42, allowing circulation of the fluid through the tubing 42 in the jacket 20. Shown is an embodiment of the personal temperature control system 10 of the invention wherein the heat exchanger incorporates a thermoelectric cooling/heating unit 46 having thermoelectric cooling (TEC) plates 48, a heat sink 50, an optional fan 52 and a controller 54 in electrical communication with the TEC plates 48. The heat exchanger also includes a heat exchanger coupling 56 for connecting to the article coupling 18, an outlet line 58 fluidly connecting the thermoelectric cooling/heating unit 46 and the heat exchanger coupling 56, a return line 60 fluidly connecting the thermoelectric cooling/heating unit 46 and the heat exchanger coupling 56, a fluid reservoir 62 in fluid communication with the outlet line 58 and the return line 60, a pump 64 in fluid communication with at least one of the outlet line 58 and return line 60, and a power supply 66 in electrical communication with the thermoelectric cooling/heating unit 46 and the pump 64.

In one embodiment, the power supply 66 is a 12 volt battery such as those typically found on motorized vehicles such as motorcycles, all terrain vehicles and snowmobiles. In another embodiment the system provides the user to be completely mobile by incorporating a self-contained rechargeable battery pack.

In addition to a primary garment, illustrated as the jacket 20, heating and cooling can be provided to one or more secondary garments, for example, the hood 22 shown in FIG. 2, which connect, directly or indirectly, to the primary garment. Preferably, the flexible tubing 16 in the primary and secondary garments connects through secondary couplings 68. Preferably, the primary garment is either pants 24 or a jacket 20, with secondary garments selected from one or more of pants 24 or jacket 20 (if not the primary garment), vest, gloves 26, hood/helmet/hat/headwear 22, socks/boots/footwear and the like. Placement of the pump 64 in the lines leading to and from the thermoelectric cooling/heating unit 46 will depend upon the particular application, with all positions finding utility. Shown is the pump 64 being inline with the return line 60. Preferably, the fluid reservoir 62 and/or the heat sink 50 is formed of a lightweight, rigid material, for example a metal such as aluminum, and most preferably the fluid reservoir 62 forms housing for the TEC plates 48. The fittings, particularly the heat exchanger coupling 56 and the article coupling 18 which connect the primary garment, shown as a jacket 20, to the thermoelectric cooling/heating unit 46, can be quick disconnect couplings, and further, can be designed to automatically disconnect at a predetermined or selectable force threshold, for example, from about 10 to about 15 pounds.

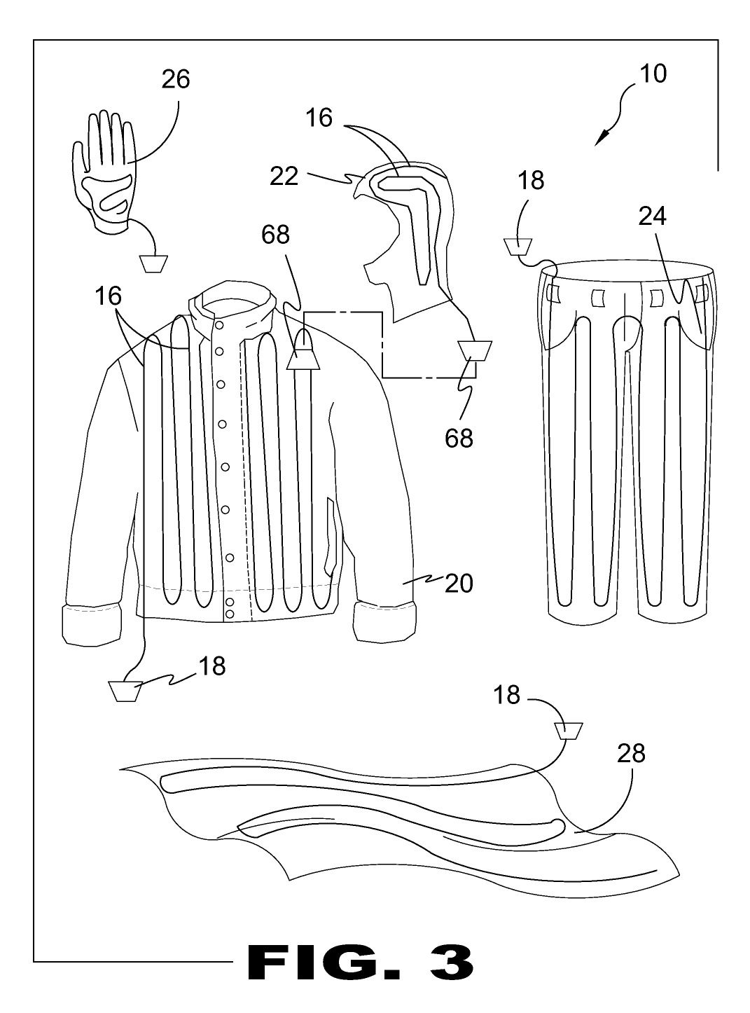

FIG. 3 illustrates various representative articles incorporating the personal temperature control system of the present invention. Shown are articles that exemplify incorporation of the personal temperature control system, such as blankets 28, gloves 26, hoods 22, pants 24 and jackets 20, each having flexible tubing 16 running through the body of the article for moving a heat transfer fluid through the article, thus performing a transfer of thermal energy between the heat transfer fluid and the wearer of the article, raising or lowering the temperature of the wearer as needed. The fluid is returned through the article couplings 18 to the conditioning unit to be heated/cooled once again.

In addition to a primary garment, such as the pants 24 or jacket 20, heating and cooling can be provided to one or more secondary garments, for example, gloves 26 and/or a hood 22, which connect, directly or indirectly, to the primary garment through secondary couplings 68. Preferably, the primary garment is either pants 24 or a jacket 20, with secondary garments selected from one or more of pants 24 or jacket 20 (if not the primary garment), vest, gloves 26, hood/helmet/hat/headwear 22, socks/boots/footwear and the like.

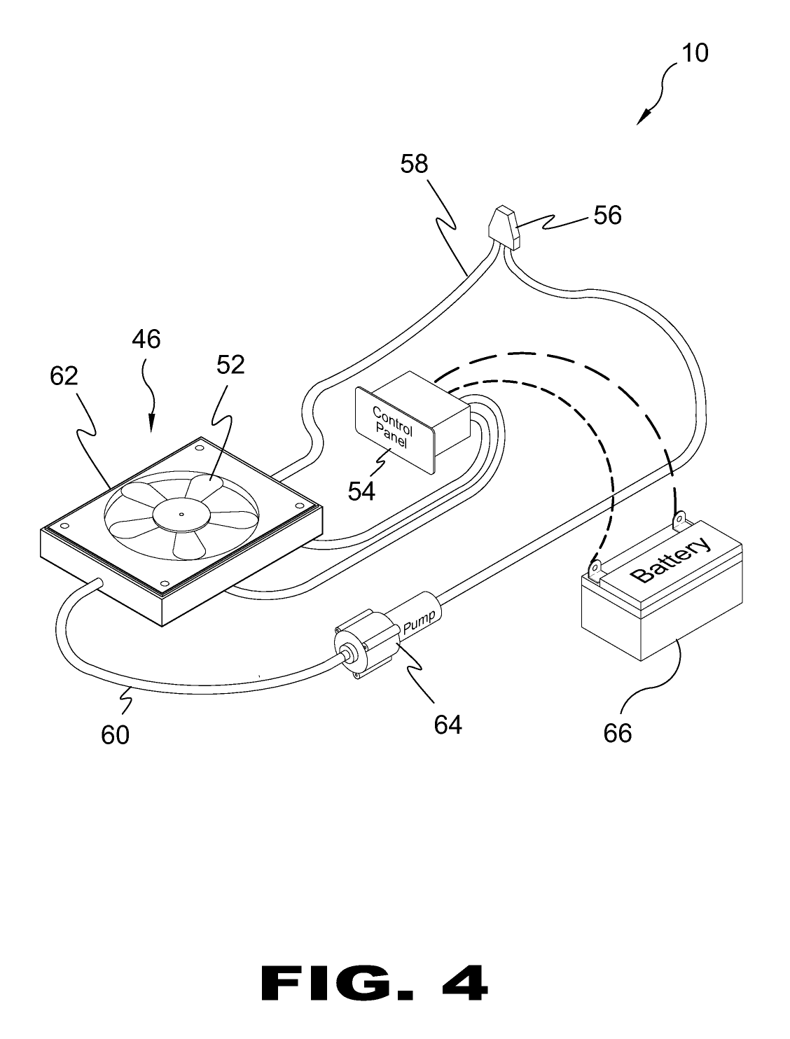

FIG. 4 is an illustrative view of the personal temperature control system of the present invention. Shown is an embodiment of the personal temperature control system 10 of the present invention wherein the heat exchanger includes a thermoelectric cooling/heating unit 46 having a fan 52, a fluid reservoir 62 in fluid communication with the outlet line 58 and the return line 60, the fluid reservoir 62 forming a housing for internal TEC plates and heat sink, and a controller 54 in electrical communication with the fan 52. The heat exchanger also includes a heat exchanger coupling 56 for connecting to the article, an outlet line 58 fluidly connecting the thermoelectric cooling/heating unit 46 and the heat exchanger coupling 56, a return line 60 fluidly connecting the thermoelectric cooling/heating unit 46 and the heat exchanger coupling 56, a pump 64 in fluid communication with at least one of the outlet line 58 and return line 60, and a power supply 66 in electrical communication with the thermoelectric cooling/heating unit 46 and the pump 64.

Placement of the pump 64 in the lines leading to and from the thermoelectric cooling/heating unit 46 will depend upon the particular application, with all positions finding utility. Shown is the pump 64 being inline with the return line 60. Preferably, the fluid reservoir 62 and/or the heat sink 50 are formed of a lightweight, rigid material, for example a metal such as aluminum. The fittings, particularly the heat exchanger coupling 56 and the article coupling 18 which connect the primary garment to the heat exchanger, can be quick disconnect couplings, and further, can be designed to automatically disconnect at a predetermined or selectable force threshold, for example, from about 10 to about 15 pounds.

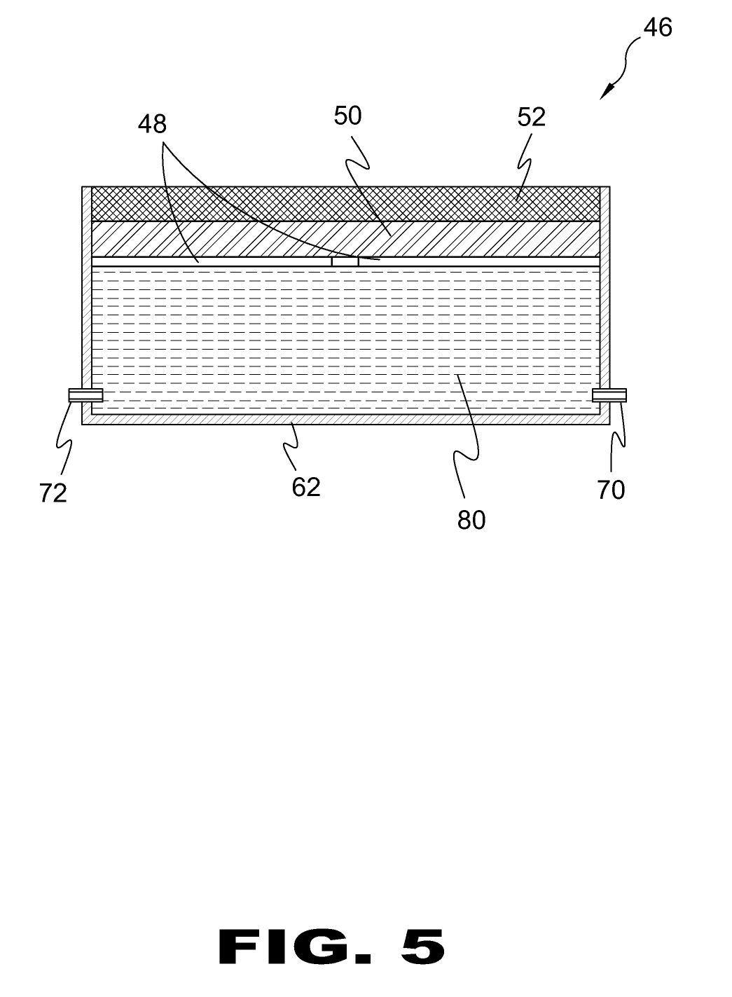

FIG. 5 is a sectional view of the personal temperature control system of the present invention. Shown is the thermoelectric cooling/heating unit 46 having thermoelectric cooling (TEC) plates 48, a heat sink 50, a fan 52, an outlet port 70, a return port 72, and a fluid reservoir 62 in fluid communication with the outlet and return lines through the outlet port 70 and return port 72, with the fluid reservoir 62 forming a housing for the TEC plates 48, heat sink 50 and fan 52. Preferably, the heat sink 50 and fluid reservoir 62 are formed of a lightweight, rigid material, for example a metal such as aluminum.

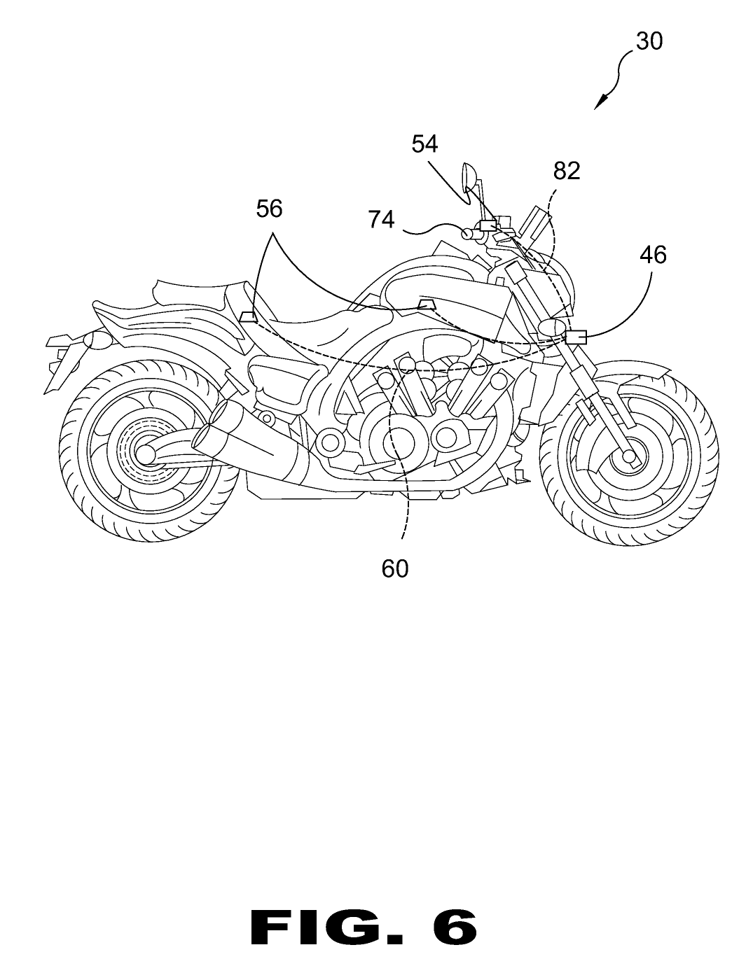

FIG. 6 is a side view of a motorized vehicle incorporating the personal temperature control system of the present invention. Shown is a motorcycle 30 having a thermoelectric cooling/heating unit 46, at least one heat exchanger coupling 56 for connecting to the heated/cooled article, an outlet line 58 fluidly connecting the unit 46 to a heat exchanger coupling 56, a return line 60 fluidly connecting the unit 46 to a heat exchanger coupling 56. The system is not limited to motorcycles and may include any non-climate controlled motorized machine such as all terrain vehicles, snowmobiles, tractors and other construction equipment. Also shown is a controller 54 mounted to the handlebar 74 of the motorcycle 30 with an electric line 82 in communication with the unit 46.

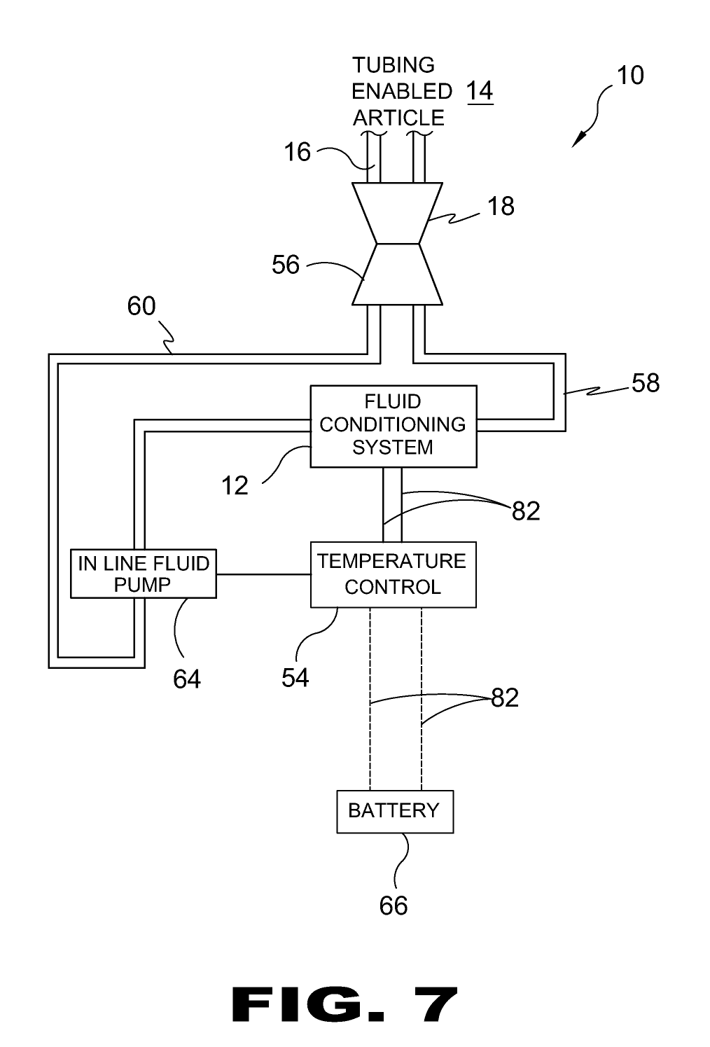

FIG. 7 is a flow chart of a preferred embodiment of the present invention. The present invention is a personal temperature control system 10 having a heat exchanger 12 which acts as a fluid conditioning system, and an article 14 fluidly connectable to the heat exchanger 12 and having flexible tubing 16 running through body of the article 14 for moving a heat transfer fluid between the heat exchanger 12 and through the article 14. A coupling 18 on the flexible tubing 16 releasably connects with a mating coupling 56 affixed to an outlet line 58 leading from the heat exchanger 12 and a return line 60 leading to the heat exchanger 12. An in-line fluid pump 64 is in fluid communication with at least one of the outlet line 58 and return line 60, preferably the return line 60. A controller 54 is in electrical 82 communication with the heat exchanger 12, and a power supply 66 in electrical communication with the controller 54 provides controlled power distribution through the controller 54 to the pump 64 and the heat exchanger 12.

In one embodiment, the power supply 66 is a 12 volt battery such as those typically found on motorized vehicles such as motorcycles, all terrain vehicles and snowmobiles. In another embodiment the system provides the user to be completely mobile by incorporating a self contained rechargeable battery pack.

The fittings, particularly the heat exchanger coupling 56 and the article coupling 18 which connect the garment to the heat exchanger 12, can be quick disconnect couplings, and further, can be designed to automatically disconnect at a predetermined or selectable force threshold, for example, from about 10 to about 15 pounds.

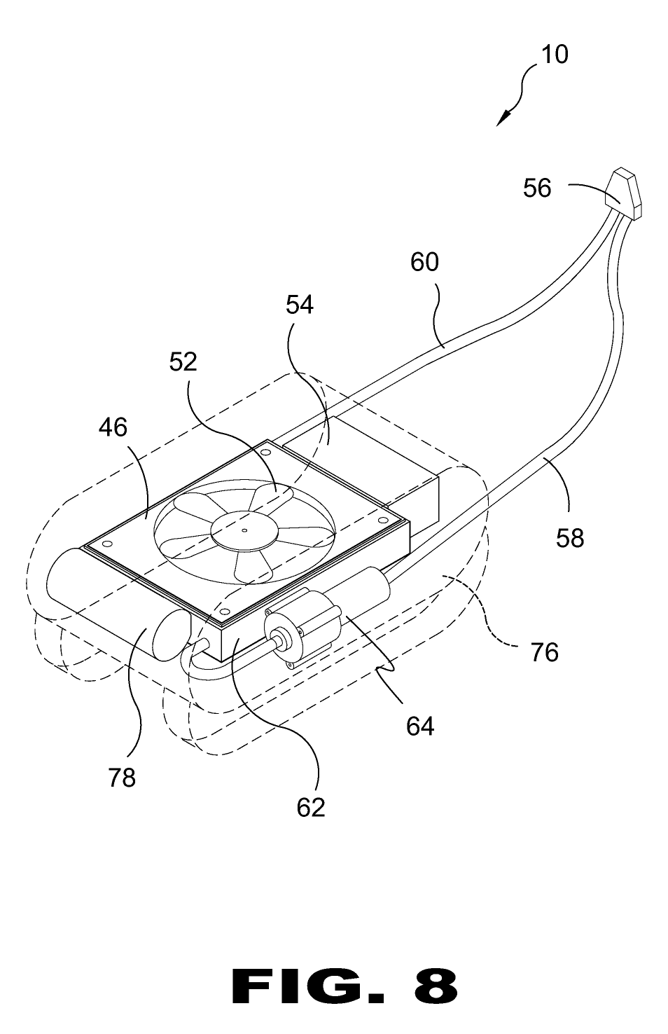

FIG. 8 is an illustrative view of an additional element of the present invention. Shown is the present invention having an embodiment whereby the present invention is self contained while being portable and operable independent of machinery or external power source via its own carry case 76 and battery 78. Shown is an embodiment of the personal temperature control system 10 of the present invention wherein the heat exchanger includes a thermoelectric cooling/heating unit 46 having a fan 52, a fluid reservoir 62 in fluid communication with the outlet line 58 and the return line 60, the fluid reservoir 62 forming a housing for internal TEC plates and heat sink, and a controller 54 in electrical communication with the fan 52. The heat exchanger also includes a heat exchanger coupling 56 for connecting to the article, an outlet line 58 fluidly connecting the thermoelectric cooling/heating unit 46 and the heat exchanger coupling 56, a return line 60 fluidly connecting the thermoelectric cooling/heating unit 46 and the heat exchanger coupling 56, a pump 64 in fluid communication with at least one of the outlet line 58 and return line 60, a pump 64 in fluid communication with at least one of the outlet line 58 and return line 60, and a battery 78 in electrical communication with the thermoelectric cooling/heating unit 46 and the pump 64.

Placement of the pump 64 in the lines leading to and from the thermoelectric cooling/heating unit 46 will depend upon the particular application, with all positions finding utility. Shown is the pump 64 being inline with the outlet line 58. Preferably, the fluid reservoir 62 and/or the heat sink 50 is formed of a lightweight, rigid material, for example a metal such as aluminum. The fittings, particularly the heat exchanger coupling 56 which connects to the article to be heated/cooled, is a quick disconnect couplings, and further, can be designed to automatically disconnect at a predetermined or selectable force threshold, for example, from about 10 to about 15 pounds. A carrying case 76 surrounds and secures the various components of the invention for easy transportation and storage.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A personal temperature control system comprising:
a) a heat exchanger;
b) an article fluidly connectable to said heat exchanger, said article having flexible tubing running through said article for circulating a heat transfer fluid between said heat exchanger and through said article; and
c) a coupling adapted to releasably connect said heat exchanger to distal ends of said flexible tubing.

2. The personal temperature control system according to claim 1, wherein said heat exchanger comprises:
a) a thermoelectric cooling/heating unit;
b) a heat exchanger coupling adapted to releasably connect to an article coupling affixed at distal ends of said flexible tubing running through said article;
c) an outlet line fluidly connecting said thermoelectric cooling/heating unit and said heat exchanger coupling;
d) a return line fluidly connecting said thermoelectric cooling/heating unit and said heat exchanger coupling;
e) a fluid reservoir in fluid communication with said outlet line and said return line;
f) a pump in fluid communication with at least one of said outlet line and said return line; and
g) a power supply in electrical communication with said thermoelectric cooling/heating unit and said pump.

3. The personal temperature control system according to claim 2, wherein said thermoelectric cooling/heating unit comprises:
a) one or more TEC plates housed within said fluid reservoir;
b) a heat sink; and
c) a controller in electrical communication with said power supply and said TEC plates.

4. The personal temperature control system according to claim 3, wherein said thermoelectric cooling/heating unit further comprises a fan.

5. The personal temperature control system according to claim 3, wherein said fluid reservoir and said heat sink are formed of aluminum.

6. The personal temperature control system according to claim 1, wherein said article is a garment or a blanket.

7. The personal temperature control system according to claim 6, wherein said article is one or more garments selected jacket, hood, pants, gloves and vest.

8. The personal temperature control system according to claim 1, wherein said heat exchanger is in a non-climate controlled motorized vehicle.

9. The personal temperature control system according to claim 8, wherein said non-climate controlled motorized vehicle is selected from a motorcycle, a utility vehicle, an all terrain vehicle, a golf cart, a snowmobile, a construction vehicle, a tractor, a fork lift and a front loader.

10. The personal temperature control system according to claim 9, wherein said coupling is a quick disconnect coupling adapted to automatically disconnect at a predetermined or selectable force threshold.

11. The personal temperature control system according to claim 10, wherein predetermined force threshold is from about 10 to about 15 pounds.

12. The personal temperature control system according to claim 1, wherein said heat exchanger is portably contained within a carry case.

13. The personal temperature control system according to claim 12, further comprising a self-contained rechargeable battery pack.

14. The personal temperature control system according to claim 1, further comprising:
a) a coupling adapted to releasably connect said heat exchanger to distal ends of said flexible tubing;
b) said article is a primary garment worn by a user;
c) said heat exchanger is in a non-climate controlled motorized vehicles; and
d) a secondary garment worn by a user, said secondary garment fluidly connectable to said primary garment, said secondary garment having flexible tubing running through said secondary garment for circulating a heat transfer fluid between said primary garment and through said secondary garment.

15. The personal temperature control system according to claim 14, further comprising secondary couplings adapted to connect said flexible tubing in said primary garment to said flexible tubing in said secondary garment.

16. The personal temperature control system according to claim 15, wherein said primary garment is selected from pants and a jacket, and said secondary garment is selected from jacket, headwear, pants, gloves vest and footwear.

17. The personal temperature control system according to claim 14, wherein said non-climate controlled motorized vehicle is selected from a motorcycle, a utility vehicle, an all terrain vehicle, a golf cart, a snowmobile, a construction vehicle, a tractor, a fork lift and a front loader.

18. A personal temperature control system comprising:
a) an article selected from a garment and a blanket having flexible tubing running through said article for circulating a heat transfer fluid through said article, and an article coupling affixed to distal ends of said flexible tubing; and
b) a heat exchanger having a thermoelectric cooling/heating unit, said thermoelectric cooling/heating unit having one or more TEC plates, an aluminum heat sink, a fan and a controller in electrical communication with said TEC plates, a heat exchanger coupling adapted to releasably connect to said article coupling, an outlet line fluidly connecting said thermoelectric cooling/heating unit and said heat exchanger coupling, a return line fluidly connecting said thermoelectric cooling/heating unit and said heat exchanger coupling, an aluminum fluid reservoir in fluid communication with said outlet line and said return line, said aluminum reservoir forming a housing for said TEC plates, a pump in fluid communication with at least one of said outlet line and said return line, and a power supply in electrical communication with said controller and said pump.

19. A method of controlling an individual's body temperature comprising the steps:
a) providing a personal temperature control system having an article selected from a garment and a blanket with flexible tubing running through said article for circulating a heat transfer fluid through said article, and an article coupling affixed to distal ends of said flexible tubing; and a heat exchanger having a thermoelectric cooling/heating unit, said thermoelectric cooling/heating unit having one or more TEC plates, an aluminum heat sink, a fan and a controller in electrical communication with said TEC plates, a heat exchanger coupling adapted to releasably connect to said article coupling, an outlet line fluidly connecting said thermoelectric cooling/heating unit and said heat exchanger coupling, a return line fluidly connecting said thermoelectric cooling/heating unit and said heat exchanger coupling, an aluminum fluid reservoir in fluid communication with said outlet line and said return line, said fluid reservoir forming a housing for said TEC plates, a pump in fluid communication with at least one of said outlet line and said return line, and a power supply in electrical communication with said controller and said pump;
b) placing said article against an individual's body;
c) connecting said article coupling with said heat exchanger coupling; and
d) controlling said personal temperature control system with said controller.

20. The method of controlling an individual's body temperature according to claim 19, further comprising:
a) a carry case portably containing said heat exchanger;
b) said power supply is a self-contained rechargeable battery pack; and
c) said article is a blanket.
